(19) United States
(12) Patent Application Publication
(10) Pub. No.: US 2006/0198926 A1
(43) Pub. Date: Sep. 7, 2006

(54) ALPHA-PYRONE COMPOSITION FOR CONTROLLING CRAVING AND AS A SUBSTITUTE FOR ALCOHOL

(76) Inventor: Gregory Gene Steiner, Kapolei, HI (US)

Correspondence Address: GODBEY GRIFFITHS REISS, 1001 BISHOP STREET, 2300 PAUAHI TOWER, HONOLULU, HI, 96813, US

(21) Appl. No.: 11/307,378

(22) Filed: Feb. 3, 2006

Related U.S. Application Data
(63) Continuation-in-part of application No. 09/596,362, filed on Jun. 17, 2000, now Pat. No. 7,048,940.
(60) Provisional application No. 60/141,805, filed on Jun. 29, 1999.

(51) Int. Cl. A23L 2/38

(52) U.S. Cl. 426/11; 426/590

(57) ABSTRACT

Administered anti-craving compositions are disclosed for preventing and treating patients with addictions comprising an effective amount of at least one alpha-pyrone compound formulated into a physiologically acceptable carrier medium. Additionally, novel compositions are disclosed as substitutes for alcoholic beverages comprising an effective amount of at least one alpha-pyrone compound formulated into alcoholic and non-alcoholic beer, wine and distilled spirits beverages.

### CROSS-REFERENCE TO RELATED PATENT APPLICATIONS

This application is a continuation-in-part of U.S. non-provisional application Ser. No. 09/596,362 filed Jun. 17, 2000, which application is based upon and claims the benefit of U.S. Provisional Application No. 60/141,805 filed Jun. 29, 1999. The entire disclosure of the prior applications is considered a part of the disclosure of this continuation-in-part application and is hereby incorporated by this reference.

### STATEMENT REGARDING FEDERALLY SPONSORED RESEARCH OR DEVELOPMENT

The subject invention is not the result of or in any way related to federally sponsored research or development.

### BACKGROUND OF INVENTION

1. Field of Invention

The present invention relates to novel therapeutic compositions comprising at least one alpha-pyrone as the active principal thereof, and to the use of such novel compositions for treating the cravings and as a substitute for alcohol.

2. Description of Prior Art

Biochemical investigation of addiction has focused on the loci of action of the substance of abuse in the brain. A great deal is known about the receptor sites for the substances of abuse. Many drugs have been designed to react with the receptor sites for substances of abuse in an effort to find an effective treatment for addiction. Considerable knowledge has developed regarding the chemicals produced in the synaptic cleft associated with the substances of abuse and the drugs designed to treat addiction.

To date a variety of drugs have been developed in an attempt to control the craving of addiction. However, no effective anti-craving medication has been identified or described in light of the fact that treatment of addiction remains psychological in nature.

Addictions to alcohol and drugs cause great physical and financial harm to the addict and to society. To date, efforts to develop effective treatments for addictions have had limited success. Temperance and legislative efforts to restrict or limit the public's access to drugs and alcohol have failed.

### SUMMARY OF THE INVENTION

A major object of the present invention is to provide compounds of the alpha-pyrone type for reducing the craving associated with addiction and compulsive behavior. A further object of the present invention is the incorporation of an effective amount of alpha-pyrones in alcoholic and non-alcoholic beverages, including alcoholic and non-alcoholic wine, beer and distilled spirit beverages, as an effective carrier for the anti-craving alpha-pyrone agents.

In addition, an effective amount of alpha-pyrones added to non-alcoholic beer, non-alcoholic wine and non-alcoholic distilled spirit beverages creates a novel alcohol substitute designed to provide the positive effects of alcohol, such as stress reduction and anxiety control, without the negative health and social effects of alcoholic beverages.

Briefly, the present invention features novel therapeutic compositions for the treatment of the cravings associated with addictions and compulsive behavior comprising in a physiologically acceptable medium, at least one alpha-pyrone having the following structural formula:

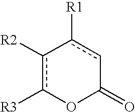

in which R1 is a hydrogen atom or an alkoxy radical having 1 to 4 carbon atoms, R2 is a hydrogen atom or a hydroxyl group, and R3 is an alkyl radical having from 1 to 4 carbon atoms or a styryl or phenethyl radical optionally substituted by one or two methylenedioxy radicals or one or two hydroxyl groups and/or one or two alkoxy radicals having from 1 to 4 carbon atoms, with the proviso that, when R2 is a hydroxyl group, then R3 is necessarily an unsubstituted phenethyl radical, with the future proviso that when R3 is an alkyl radical having 1 to 4 carbon atoms, then R1 and R2 cannot both be hydrogen.

### DETAILED DESCRIPTION OF THE INVENTION

The present invention involves administering compositions containing alpha-pyrones that reduce the cravings of addictions and reduce compulsive behavior. According to the embodiments of this invention, craving means and includes obsessive compulsion for indulgence in substances which are classed as psychoactive drugs and/or which act to enhance the effect of endogenous and/or exogenous neuropeptides, neorotransmitters and psychoactive agents. Psychoactive drugs include but are not limited to alcohol, opiates, stimulants, barbiturates, nicotine and food. Compulsive acts which affect endogenous and/or endogenous neuropiptides, neuropeptides and psychoactive agents include but are not limited to sexual acts and other compulsive behaviors.

One embodiment of the present invention comprises the addition of alpha-pyrones to alcoholic beverages. According to this embodiment, the person is consuming alcohol as he or she is being treated for cravings. The craving for continued drinking is resolved by the consumption of alpha-pyrones and, meanwhile, the consumption of alcohol is reduced. Eventually the person can reduce the amount of alcohol consumed by reducing the amount of alcohol in the alpha-pyrone containing beverage.

In another embodiment, the invention involves the addition of alpha-pyrones to non-alcoholic beer, non-alcoholic wine and non-alcoholic distilled spirit beverages, as an alcohol substitute. According to this embodiment, an effective amount of alpha-pyrones is added to beverages that contain little or no alcohol but which are formulated to simulate the taste and aroma of beverages that typically contain alcohol, such as beer, wine and distilled spirits.

For the purposes of these embodiments, non-alcoholic beverages, non-alcoholic beer, non-alcoholic wine, and non-alcoholic distilled spirits beverages include beverages that have less than the amount of alcohol required to be considered alcoholic for the particular type and/or class of beverage. Accordingly, the non-alcoholic beverages described herein range in alcohol content from having a moderate amount of alcohol to having no alcohol.

Alpha-pyrones called kavapyrones are naturally found in the kava plant (Piper methysticum). Traditionally, Kava is consumed in order to achieve a relaxed state with a positive mood and a mild euphoria. Kava is intoxicating when large amounts are consumed. However, because kava is nonaddicting (Lebot V. 1992) and does not cause craving or tolerance/dependence, intoxication is essentially unheard-of. The lack of craving and tolerance/dependence results from an effective amount of active alpha-pyrones in kava acting on the dopaminergic neurons of the nucleus accumbens.

This invention involves a novel use of alpha-pyrones, commonly known as kavapyrones, which are found in the kava plant (Piper methysticum).

The commonly accepted actions of the alpha-pyrones found in kava which are referenced in the literature are as an anti-anxiety agent (Voltz 1997), antidepressant (Warnecke G et al 1998), euphoriant (Baum S S et al., 1998), muscle relaxant (Seitz 1997), analgesic (Jamieson 1990), anticonvulsant (Kretzschmar R 1969) and as a topical treatment for hair loss (U.S. Pat. No. 558,368). Kava consumption has been found to be directly correlated with a reduction in cancer incidence for a number of South Pacific Nations and is being studied as an effective anticancer agent. (Steiner G G 2000).

Kavapyrones have become popular in the West as anti-anxiety agents. No side effects have been identified when used on a daily basis in moderate amounts (German Commission E). Years of daily use has been found to cause a dermatologic scaling which is reversed when the drug is discontinued (Norton S A et al., 1994). No irreversible side effects have been noted.

Among the alpha-pyrone compounds comprising the therapeutic compositions of the invention are the following: 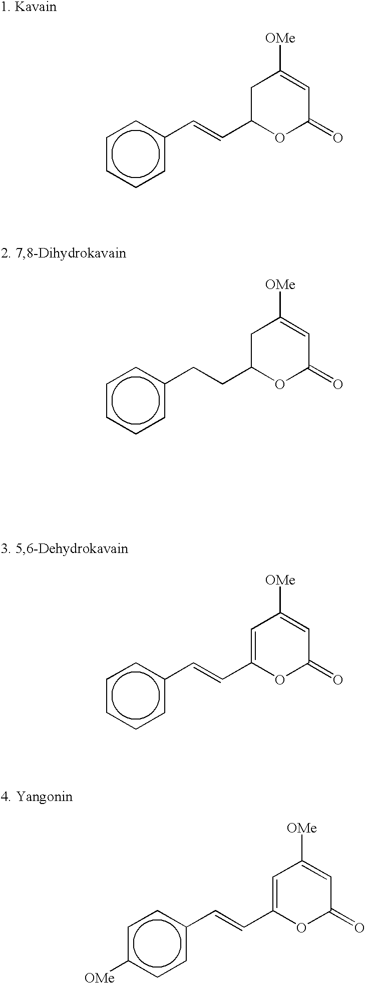 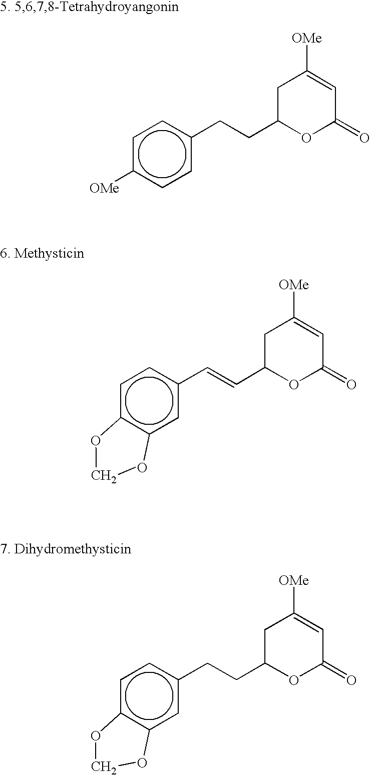 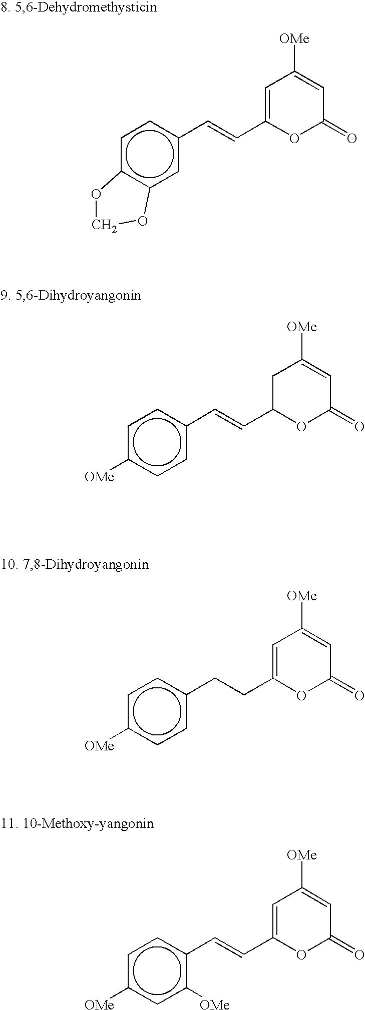 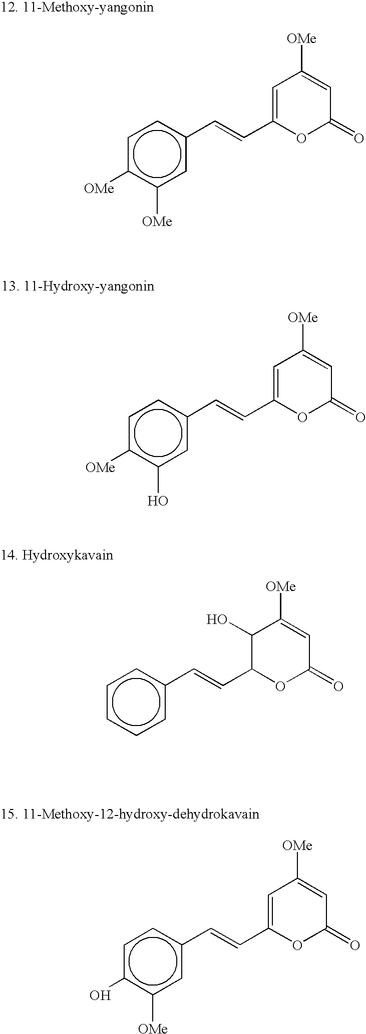
All of these alpha-pyrone compounds are per se known to this art.

The anti-craving effects of kavapyrones are mediated through the dopaminergic neurons of the nucleus accumbens in the mesocorticolimbic dopamine reward system. This system is not only responsible for the craving of substances of abuse but is also the same mechanism that produces natural motivation for food, water, sex, etc. When kavapyrones are administered in vivo by microdialysis into the nucleus accumbens, increasing doses of kavapyrones produce increased levels of dopamine (Baum, 1998). The kavapyrone desmethoxyyangonin produces an increase in dopamine, while the kavapyrone yangonin decreases dopamine to undetectable levels (Baum S S et al., 1998). It is through the mesocorticolimbic dopamine reward system that kava increases dopamine in pathways which produce euphoria and an anti-craving effect, and functions by acting as an antagonist for those dopaminergic neurons responsible for acute craving and its effect on 5-HT (Baum S S et al., 1998).

Kavapyrones are known to influence the function of GABAA receptors. It is through the influence on the GABAA receptor that kava produces anxiolytic effects similar to alcohol, benzodiazepines and barbiturates. However, alcohol, benzodiazepines and barbiturates are known antagonists of NMDA while kava is an agonist (Walden J et al., 1997). This finding supports the fact that kava produces either a mildly stimulating or a mildly sedating effect, depending on the preparation and dose. It is also this difference that explains why kava produces little effects on mental and motor function and seldom causes intoxication.

The alpha-pyrone compounds are preferably employed in doses ranging from approximately 5 mg to 600 mg every three to four hours, depending on the severity of the craving, the specific alpha-pyrone, and the weight of the patient.

Alpha-pyrones known as kavapyrones are present in the plant Piper methysticum. The kavapyrones may be extracted using one of a number of known extraction techniques. These compounds may also be synthesized according to a variety of processes described in the literature.

Physiologically accepted media that may be used to carry an effective amount of alpha-pyrone include inert carriers such as a pill or gum, or a cigarette. The physiologically accepted medium used to carry an effective amount of alpha-pyrone in a transdermal patch requires the addition of organic solvents to facilitate transport of the alpha-prone across the skin for systemic distribution.

Addictions are complex physiologic and psychological disorders which require treatment of both the mental and physical aspects of the addiction for success. In alcoholism, it has been found most effectual to not only treat the craving for alcohol but to also satisfy the patients desire for the taste, aroma, feeling and the act of drinking. For this reason a novel aspect of the invention involves the addition of an effective amount of alpha-pyrones to beverages that contain little or no alcohol but that that simulate the taste and aroma of beverages typically containing alcohol, such as beer, wine and distilled sprits. In this manner the taste, aroma, experience and a similar feeling is achieved when drinking the non-alcoholic alpha-pyrone beverage. When an effective amount of alpha-pyrone is substituted for alcohol in beverages that simulate the taste and aroma of beer, wine or distilled sprits, patient compliance improves along with the reduction in craving and an improved abstinence from alcohol.

In clinical trials, 80% of alcoholics consuming alpha-pyrone containing compositions reported a resolution of craving for alcohol. In trials for tobacco, cocaine and heroine, 100% of the respondents reported a reduction in their craving after consuming an effective amount of alpha-pyrones.

In a double blind placebo controlled study of alcoholics, patients receiving an effective amount of alpha-pyrone achieved abstinence form alcohol more frequently than those taking the placebo (P=0.05).

The most effective physiologically acceptable medium used to carry an effective amount of alpha-pyrone for the treatment of the cravings of alcoholism has been found to be non-alcoholic beverages that simulate or mimic the taste, aroma, appearance and experience of alcoholic beverages. In this instance the alcoholic patient is not deprived of the enjoyment of his/her beverage of choice and is not required to alter his/her social habits while abstaining form alcohol. The addition, of an effective amount of alpha-pyrone for the treatment of craving to non-alcoholic beer, non-alcoholic wine and non-alcoholic distilled sprits provides an ideal delivery medium through which to achieve muscle relaxation, stress reduction, mild euphoria and a reduction in the craving for the substance of abuse.

The mesocorticolimbic dopamine system is implicated in motivation and reward and is believed to be involved in the development of alcoholism. It has been found that cues such as the smell of alcoholic beverages stimulates the mesocorticolimbic dopamine system (Kareken D A et al). In the laboratory it has been found that much more alcohol is consumed if it is in beer than if the same amount of alcohol is in another solution (McGregor I S et al). Pictorial depictions of alcohol related cues result in neurophysiological responses related to craving (Mathalon D).

Providing the anti-craving compound at the same time as stimulating the craving response with alcohol cues improves the efficiency with which patients reach alcohol abstinence. It is believed that kavapyrones are more effective is controlling craving and producing abstinence when the patient is actively craving because, in this manner, the kavapyrones are treating the relevant portion of the brain when it is most active, resulting in a prolonged effect and overall continued reduction in craving for alcohol.

Non alcoholic beverages rank very poorly in taste. Because of this the sales of nonalcoholic beer, wine and sprits is a very small fraction of their alcoholic counterparts. The addition of kavapyrones to nonalcoholic beer, wine and sprits produces a beverage with a remarkable similarity in taste, look and odor to their alcoholic counterparts. The addition of kavapyrones to nonalcoholic beer wine and sprits was found to be an acceptable and appreciated substitute for alcoholic beverages.

A major impediment for achieving sobriety for many alcoholics is that treatment plans require alcoholics to avoid contact with alcohol or where is served. This requires alcoholics to give up many of the friends and social gatherings that make their life enjoyable. For this reason many alcoholics relapse because they are not willing to forsake the people and activities that give them pleasure.

In order to reach those individuals who are not willing to forgo their friends and social life in order to give up alcohol, the novel idea was developed of adding an anti-craving compound to a nonalcoholic beer, wine or distilled sprit that produces a pleasant tasting beverage, a relaxed feeling of well being, and increased social interaction. Nondrinkers enjoy the beverage and are made to feel a part of social gatherings because they are able to participate equally with those enjoying standard alcoholic beverages. Alcoholics can enjoy the company of friends at social settings where alcohol is being served without the craving to drink alcohol. Nondrinkers at social gathering where alcohol is being served reported that they preferred the taste of the kavapyrone nonalcoholic beer wine or sprits over the alcoholic beverages and preferred the feeling produced by the kavapyrone nonalcoholic beer wine or sprit over the feelings produced by alcohol.

The use of kavapyrones as an anti-craving agent in nonalcoholic beer, wine or spirit was found to be not only an effective method for the alcoholic to reach and maintain sobriety, but also a way for individuals to prevent the onset of alcoholism. The non-drinker who consumed kavapyrone nonalcoholic beer wine or sprits did not demonstrate a desire to consume alcohol or experiment with alcohol consumption going forward.

While this invention has been particularly shown and described with reference to preferred embodiments thereof, it will be appreciated by those skilled in the art that various changes in the form and details may be made therein without departing from the scope of the invention. The scope of the invention should be determined by the appended claims and their legal equivalents rather than with reference to any particular example, embodiment or illustration.

### REFERENCES

The teachings of all citations are incorporated herein in their entireties by reference.

Baum S S, Hill R, Rommelspacher. Effect of kava extract and individual kavapyrones on neurotransmitter levels in the nucleus accumbens of rats. Prog Neuropsychopharmacol Biol Psychiatry 1998 October; 22(7):1105-20

German Commision E monograph on Kava

Jamieson D D, Duffield P H. The antinociceptive actions of kava components in mice. Clin Exp Pharmacol Physiol 1990 July; 17(7):495-507

Kareken D A, Claus E D, Sabri M, Dzemidzic M, Kosobud A E, Radnovich A J, Hector D, Ramchandani V A, O'Connor S J, Lowe M, Li T K. Alcohol-related olfactory cues activate the nucleus accumbens and ventral tegmental area in high-risk drinkers: preliminary findings. Alcohol Clin Exp Res. 2004 April; 28(4):550-7.

Kretzschmar R, Meyer H J. Comparative studies on the anticonvulsant activity of the pyrone compounds of Piper methysticum Forst. Arch Int Pharmacodyn 1969; 177:261-267.

Lebot V, Merlin M, Linstrom L. Kava the Pacific Drug. New Haven, Conn.: Yale University Press; 1992:10

Mathalon D., Neural circuitry of P300 abnormalities in alcoholics: relationships to alcohol cue reactivity. A pilot study.

McGregor I S, Gallate J E., Rats on the grog: novel pharmacotherapies for alcohol craving. Addict Behav. 2004 September; 29(7):1341-57.

Norton S A, Ruze P. Kava dermopathy. J Am Acad Dermatol 1994 July; 31(1):89-97

Seitz U, Schule A, Gleitz J. [3H]-monoamine uptake inhibition properties of kava pyrones. Planta Med 1997; 63:548-549.

Steiner G G. The correlation between cancer incidence and kava consumption. Hawaii Med. J. 2000 November; 59(11):420-2.

Uebelhack R, Franke L, Schewe H J. Inhibition of platelet MAO-B by kava pyrone-enriched extract from Piper methysticum Forster (kava-kava) Pharmacopsychiatry 1998 September; 31 (5):187-92

Volz H P, Kieser M. Kava-kava extract WS 1490 versus placebo in anxiety disorders in a randomized placebo-controlled 25-week outpatient trial. Pharmacopsychiatry 1997; 30:1-5

Walden J, von Wegerer J, Winter U, Berger M, Grunze H Effects of kawain and dihydromethysticin on field potential changes in the hippocampus. Prog Neuropsychopharmacol Biol Psychiatry 1997 May; 21(4):697-706

Warnecke G. Psychosomatic dysfunctions in the female climacteric. Clinical effectiveness and tolerance of Kava Extract WS 1490 Fortschr Med 1991 Feb. 10; 109(4):119-22

What is claimed is:

1. An alcoholic beverage containing a composition of matter comprising an effective amount of at least one alpha-pyrone compound having the structural formula: 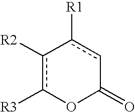
wherein R1 is a hydrogen atom or an alkoxy radical having 1 to 4 carbon atoms, R2 is a hydrogen atom or a hydroxyl group, and R3 is an alkyl radical having from 1 to 4 carbon atoms or a styryl or phenethyl radical optionally substituted by one or two methylenedioxy radicals or one or two hydroxyl groups and/or one or two alkoxy radicals having from 1 to 4 carbon atoms, with the proviso that, when R2 is a hydroxyl group, then R3 is necessarily an unsubstituted phenethyl radical, with the future proviso that when R3 is an alkyl radical having 1 to 4 carbon atoms, then R1 and R2 cannot both be hydrogen.

2. The beverage of claim 1 wherein the beverage is beer.

3. The beverage of claim 1 wherein the beverage is wine.

4. The beverage of claim 1 wherein the beverage is distilled spirits.

5. A non-alcoholic beverage formulated to simulate the taste and aroma of an alcoholic beverage and containing a composition of matter comprising an effective amount of at least one alpha-pyrone compound having the structural formula: 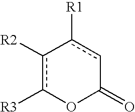
wherein R1 is a hydrogen atom or an alkoxy radical having 1 to 4 carbon atoms, R2 is a hydrogen atom or a hydroxyl group, and R3 is an alkyl radical having from 1 to 4 carbon atoms or a styryl or phenethyl radical optionally substituted by one or two methylenedioxy radicals or one or two hydroxyl groups and/or one or two alkoxy radicals having from 1 to 4 carbon atoms, with the proviso that, when R2 is a hydroxyl group, then R3 is necessarily an unsubstituted phenethyl radical, with the future proviso that when R3 is an alkyl radical having 1 to 4 carbon atoms, then R1 and R2 cannot both be hydrogen.

6. The non-alcoholic beverage of claim 5 wherein the beverage contains no ethanol.

7. The non-alcoholic beverage of claim 5 wherein the beverage contains 0.5% or less ethanol by volume.

8. The non-alcoholic beverage of claim 5 wherein the beverage contains 1% or less ethanol by volume.

9. The non-alcoholic beverage of claim 5 wherein the beverage contains 1.5% or less ethanol by volume.

10. The non-alcoholic beverage of claim 5 formulated to simulate the taste and aroma of wine.

11. The non-alcoholic beverage of claim 5 formulated to simulate the taste and aroma of beer.

12. The non-alcoholic beverage of claim 5 formulated to simulate the taste and aroma of distilled spirits.
